(19) United States
(12) Patent Application Publication
(10) Pub. No.: US 2023/0252271 A1
(43) Pub. Date: Aug. 10, 2023

(54) ELECTRONIC DEVICE AND METHOD FOR PROCESSING DATA BASED ON REVERSIBLE GENERATIVE NETWORKS, ASSOCIATED ELECTRONIC DETECTION SYSTEM AND ASSOCIATED COMPUTER PROGRAM

(71) Applicant: COMMISSARIAT A L'ENERGIE ATOMIQUE ET AUX ENERGIES ALTERNATIVES, Paris (FR)

(72) Inventor: Johannes Christian THIELE, Gif Sur Yvette Cedex (FR)

(73) Assignee: COMMISSARIAT A L'ENERGIE ATOMIQUE ET AUX ENERGIES ALTERNATIVES, Paris (FR)

(21) Appl. No.: 18/004,640

(22) PCT Filed: Jul. 7, 2021
(86) PCT No.: PCT/EP2021/068861

§ 371 Date: Jan. 6, 2023

(30) Foreign Application Priority Data
Jul. 9, 2020 (FR) FR2007287

(51) Int. Cl. G06N 3/0475; G06N 3/047

(52) U.S. Cl. CPC G06N 3/0475; G06N 3/047

(57) ABSTRACT

An electronic device for processing data, including an acquisition module for acquiring a set of data to be processed, a calculation module including a plurality of components, each associated with a respective task, each component being configured to implement a reversible neural network to calculate a vector in a latent space, called latent vector, on the basis of the set of data, and a determination module for determining a task for each data, by: evaluating, for each component, a likelihood score from the corresponding latent vector, assigning, to said data, the task associated with the component with the highest likelihood score among the plurality of evaluated scores, and if the evaluated likelihood score is inconsistent for the component associated with the assigned task, modifying the assigned task to an unknown task.

The present invention relates to an electronic data processing device, as well as to a data processing method implemented by such an electronic processing device.

The invention also relates to an electronic object detection system, comprising a sensor, such as an image sensor, and such an electronic processing device, each data to be processed being an object detected in a respective image.

The invention also relates to a computer program including software instructions which, when executed by a computer, implement such a processing method.

The invention then concerns the field of machine learning, in particular that of continuous learning based on generative neural networks, in particular for data processing, such as data classification and latent feature learning.

By neural network, we mean an artificial neural network known per se.

The invention then offers various applications, such as the classification or identification of objects previously detected by an object detector, allowing for example to learn the identities of people whose faces have been detected by a face detector. Another application is an automatic and unsupervised feature learning system, for example a system that is trained in an autonomous and continuous manner on human voice data around it, and the learned features are then used to preprocess data for a learning system specialized on a certain person's voice.

When a neural network for data processing, and in particular for classification, is trained for a task, also called a class in the case of use for data classification, such as a first task, or first class, and is then trained for another task, namely a second task, or second class, the neural network will forget the information learned on the first task and will then be unable to perform the first task again, this phenomenon being also known as catastrophic forgetting.

In a known way, neural networks for data processing, and in particular for classification, are then trained simultaneously on a plurality of tasks, or classes, examples representing these different tasks having then to be distributed in a homogeneous way in a set of training data. Moreover, these neural networks are typically trained on a number of tasks that is fixed at the beginning of their training.

In order to remedy this catastrophic forgetting phenomenon, methods are also known, such as an Elastic Weight Consolidation (EWC) method, or a Synaptic Intelligence (SI) method, which consists in finding a metric assigning an importance to each parameter used for the execution of a certain task, after having learned it. If a parameter is important for the execution of a task, then it is more difficult to change when learning subsequent tasks.

However, such methods require additional variables to be saved, and the calculation of the importance of each parameter for each task is then often expensive in terms of calculating resources and/or calculation time. Also, such methods are generally used only for cases where the tasks do not differ too much from each other.

Other methods that seek to solve the catastrophic forgetting phenomenon use generative models to produce artificial data that resembles the data of previously learned tasks.

Generative models aim to represent an input space X in an output space Y, by defining, for example, a joint probability distribution or bijective functions for all possible variables, in other words, for the variables of the output space Y, also called output variables and corresponding to the data to be predicted; for the variables of the input space X, also called input variables and corresponding to the data received as input of the generative model; and for the variables of an unobserved space, also called latent space H, also noted Z, these unobserved annex variables being, then, also called latent or hidden variables. These latent variables therefore correspond to vectors of the latent space H, also called latent vectors. When generative models are used for data processing, and in particular for data classification, the output space Y corresponds to the task space, and the output variables then represent task labels associated with the input data.

Such methods are often considered as implementing a generative replay approach or even pseudo-rehearsal. With these methods, the artificial data produced are used in combination with data from a new task to train the neural network(s) used for data processing, and in particular for data classification. The paper “Continual Unsupervised Representation Learning” by Rao et al, 33rd Conference on Neural Information Processing Systems (NeurIPS 2019), describes an example of such a generative retraining method.

However, with such generative retraining methods, it is necessary to have a very good quality generative model that is able to generate good representations of the already learned tasks.

The purpose of the invention is then to propose an electronic data processing device, and an associated processing method, which provides a better solution to the phenomenon of catastrophic forgetting by better representing tasks, or classes, and then learning features that are more discriminating.

To this end, the invention has as its object an electronic data processing device, comprising:
an acquisition module configured to acquire a set of data to be processed;
a calculation module including a plurality of components, each associated with a respective task, each component being configured to implement a reversible neural network to calculate a vector in a latent space, called latent vector, from the set of data;
a determination module configured to determine a task for each data, by:
   evaluating, for each component, a likelihood score from the corresponding latent vector; and
   assigning, to said data, the task associated with the component with the highest likelihood score among the plurality of evaluated scores; and
   if the evaluated likelihood score is inconsistent for the component associated with the assigned task, modifying the assigned task to an unknown task.

Thus, the electronic processing device according to the invention offers continuous learning based on generative neural networks, the networks of the calculation module being in addition reversible neural networks (normalizing flow networks) which each then learn a bijective function between the input space X and the latent space H. The latent space H is then distributed according to a probabilistic distribution function of the same dimension as the input space X, each probabilistic distribution function being, for example, a multidimensional Gaussian. The possibility of inverting the neural network of each component allows to express the data likelihood function of the input space X more easily according to the values of the latent space H.

Reversible networks also allow an exact calculation of the likelihood score of the data in the input space X according to the probabilistic distribution function p_{X} of the input space X. Also, if the likelihood score of a sample is inconsistent for the component associated with the assigned task, for example if the likelihood score deviates too much from the average score observed during training of said component, this sample is considered to be of unknown task. The electronic processing device according to the invention then allows to perform, in addition, a detection of unknown task(s), or unknown class(es).

Furthermore, the use of a reversible neural network for each component of the calculation module allows to use the same and unique neural network for encoding from the input space X toward the latent space H, and for decoding from the latent space H toward the input space X, this decoding typically allowing to create artificial examples of data, for the subsequent retraining of the neural networks of the components.

Another advantage of reversible networks is the possibility to implement the gradient backpropagation algorithm with less memory resources, as the activations of each neuron can be reconstructed from the output of the network. This allowing to recalculate the activations in parallel during a backpropagation phase, which avoids having to save the activations of each neuron during an inference phase. The invention is then particularly suitable for the implementation of a continuous learning system with less memory resources, such as an embedded system.

Preferably, the neural network parameters of each component are able to be optimized using a maximum likelihood estimation on the data of the input space X.

Even more preferably, the neural network of each component is learned using a backpropagation algorithm for calculating the gradient of each parameter of the network according to a cost function, the cost function typically including a likelihood term, such as a log likelihood term.

According to other advantageous aspects of the invention, the electronic processing device comprises one or more of the following features, taken alone or in any technically possible combination:
the device further comprises a feedback module configured to store each unknown task data in a buffer memory, and to trigger the creation of a new task if the number of data stored in the buffer memory is greater than a predefined number;

the calculation module being then configured to include a new component associated with the new task; the learning of the new component being carried out from said data stored in the buffer memory;
the reversible neural network of each component includes parameters, such as weights; said parameters being optimized via a maximum likelihood method;

the learning of said network being preferably performed via a backpropagation algorithm for calculating the gradient of each parameter;

the learning of said network being preferably still continuous, in particular after each data processing;
the device further comprises a feature extraction module connected between the acquisition module and the calculation module, the extraction module being configured to implement at least one neural network to convert the set of data into a simplified representation, by extracting one or more features common to the plurality of tasks;

each neural network of the extraction module being preferably invertible;
the extraction module preferably even including a first extractor configured to implement a neural network with fixed weights following the training of said network and a second extractor configured to implement a neural network with trainable weights via continuous training, such as training carried out after each processing of data, in particular via an inverse propagation algorithm;
the determination module is further configured to generate a vector of random or pseudo-random number(s) corresponding to the distribution of the latent space of one of the components, and then to propagate said vector in an inverse manner via the corresponding reversible neural network, in order to create an artificial example of data, a task identifier associated with this artificial example being an identifier of said component;

said vector being preferably propagated in an inverse manner to the calculation module or to a retraining module distinct from the calculation module;
the device further comprises a retraining module configured to receive the vector generated by the determination module and to supply at least one artificial example of data and its identifier to the component(s) of the calculation module associated with the same identifier, said component(s) able to be retrained, the retraining module including a copy of each component to be retrained;
when the extraction module includes the first extractor and the second extractor, the retraining module also includes a copy of the second extractor, the retraining module then being further configured to provide at least one artificial example of data to the second extractor of the extraction module;
the device is configured to perform unsupervised learning of tasks, each component of the calculation module being configured to calculate a vector in the latent space for each new data, the latent space then including latent vectors for this new data, an identifier of the component being furthermore associated with each calculated latent vector;
the determination module is further configured to modify the component identifiers from a batch of identified examples, a respective identifier being associated with each example, by assigning for each example its identifier to the component presenting the highest likelihood score, the component or components not having an identifier assigned after taking into account all the examples of the batch being ignored;
the likelihood score is a logarithmic score;

the likelihood score preferably including the following logarithmic term:

log[p_{H}^{k}(F^{k}(x))],

where H represents a space of latent vectors, also called latent space,

p_{H} is a probabilistic distribution function of the latent space H,

k is an integer index representing each component, k typically being between 1 and P, with P representing the number of components, P≥2,

F^{k} is an invertible, or bijective, function relating a latent vector h^{k} to the set x of data: h^{k}=F^{k}(x);
the evaluated likelihood score is inconsistent for the component associated with the assigned task if the difference between the evaluated likelihood score and an average likelihood score for said component is greater than a threshold;

said threshold preferably being a predefined value for each component, or even a percentage of an observed average value for each component;

an out-of-distribution detection method is alternatively applied to the likelihood scores evaluated for the detection of unknown sample(s);
the determination module is further configured to transmit the latent vectors to another electronic data processing device, such as a k-NN classifier or another neural network;
the acquisition module is further configured to perform a normalization of the sets of data and/or an enrichment of the sets of data, for example via one or more random angle rotations.

The invention also has as its object, an electronic objects detection system, the system comprising a sensor, such as an images sensor, a sound sensor or an object detection sensor, and an electronic data processing device connected to the sensor, the electronic processing device being as defined above, and each data to be processed is an object detected in an image.

The invention also has as its object a data processing method, implemented by an electronic processing device and comprising the following steps:
acquiring a set of data to be processed;
calculating, via the implementation of a reversible neural network for each component of a plurality of components, a vector in a latent space, known as a latent vector, for each component and from the set of data, each component being associated with a respective task;
determine a task for each data, by:
   evaluating, for each component, a likelihood score from the corresponding latent vector; and
   assigning, to said data, the task associated with the component with the highest likelihood score among the plurality of evaluated scores; and
   if the evaluated likelihood score is inconsistent for the component associated with the assigned task, modifying the assigned task to an unknown task.

The invention also has as its object to provide a computer program including software instructions which, when executed by a computer, implement a processing method, such as defined above.

These features and advantages of the invention will become clearer upon reading the following description, given only as a non-limiting example, and made with reference to the attached drawings, in which:

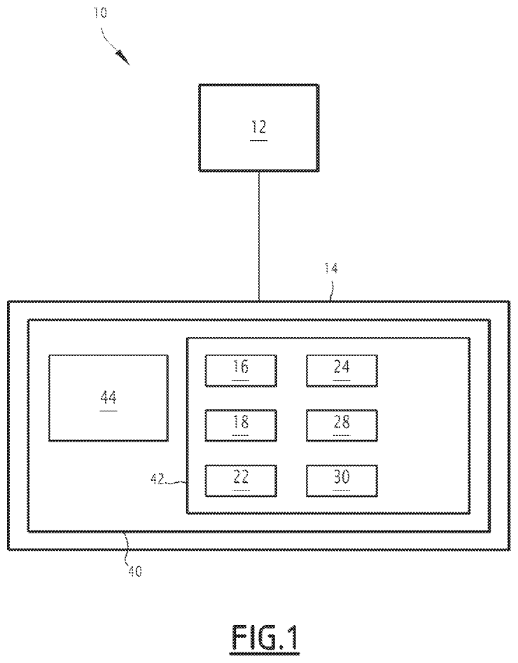

FIG. 1 is a schematic representation of an electronic object detection system according to the invention, comprising a sensor and an electronic data processing device, connected to the sensor;

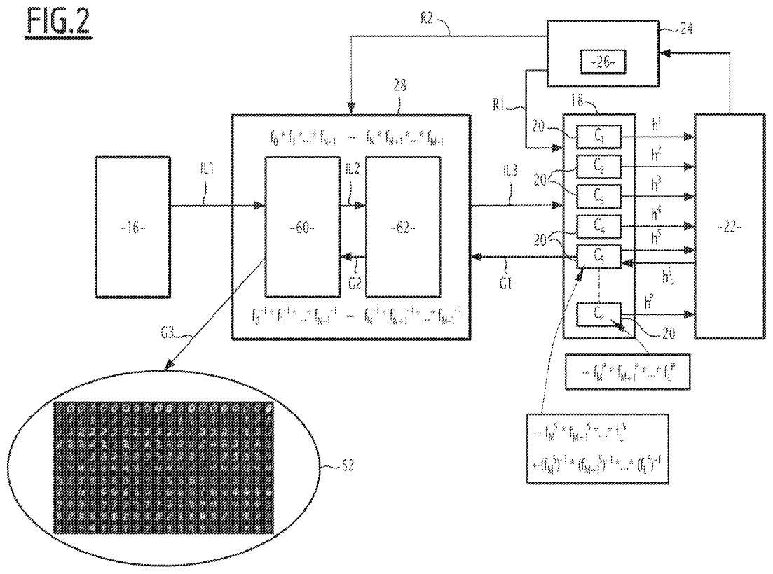

FIG. 2 is a more detailed schematic representation of the electronic processing device of FIG. 1, comprising in particular a calculation module including a plurality of components, each of which is associated with a respective task and configured to implement a reversible neural network to calculate a vector in a latent space from a set of data to be processed, according to a first embodiment;

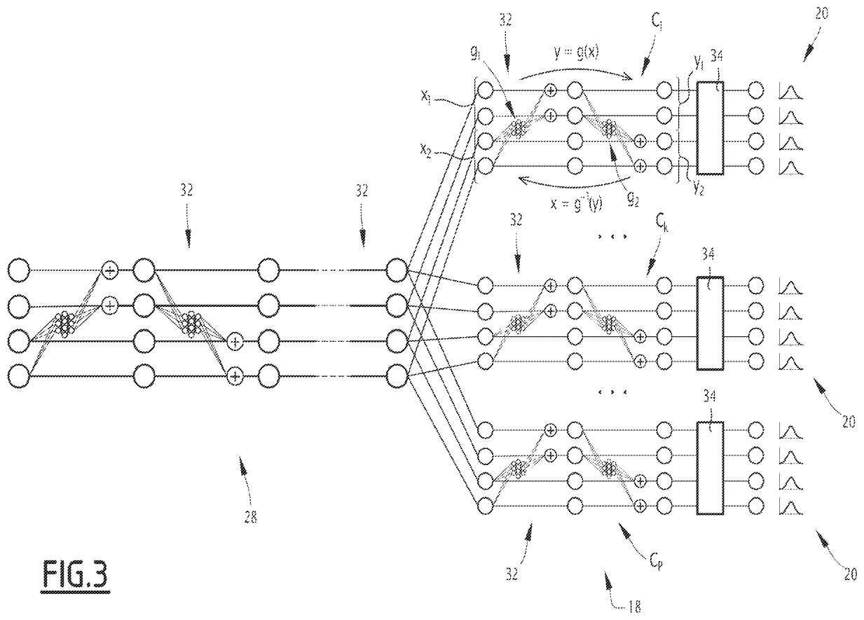

FIG. 3 is a schematic representation of an example of implementation of the reversible neural networks of the components of the calculation module of FIG. 2, these reversible neural networks being optionally connected to the reversible neural network of a feature extraction module included in the electronic processing device of FIGS. 1 and 2, in addition to the calculation module;

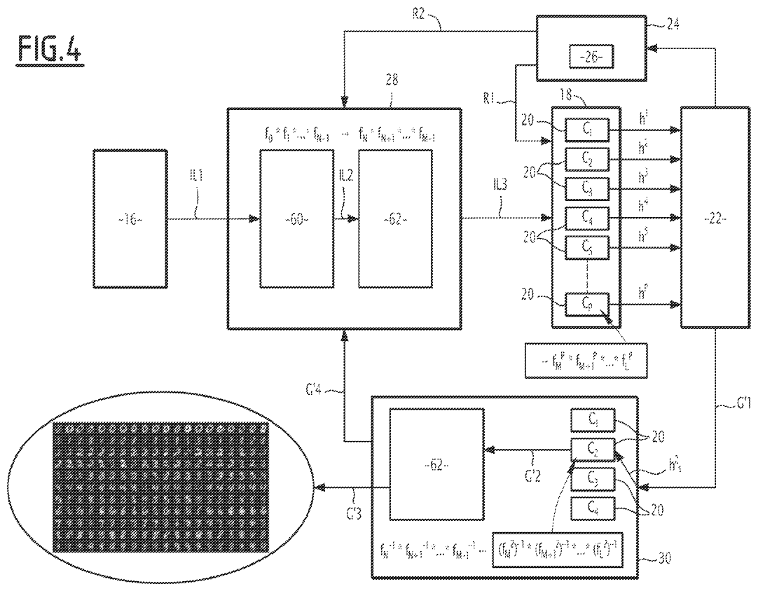

FIG. 4 is a similar view to that of FIG. 2, according to a second embodiment of the invention, in which the electronic processing device further comprises a retraining module configured to supply, from a latent vector, at least one artificial example and its identifier, to the component(s) of the calculation module associated with the same identifier as that of the artificial example, said component(s) able to be retrained, and the retraining module including a copy of each component to be retrained; and

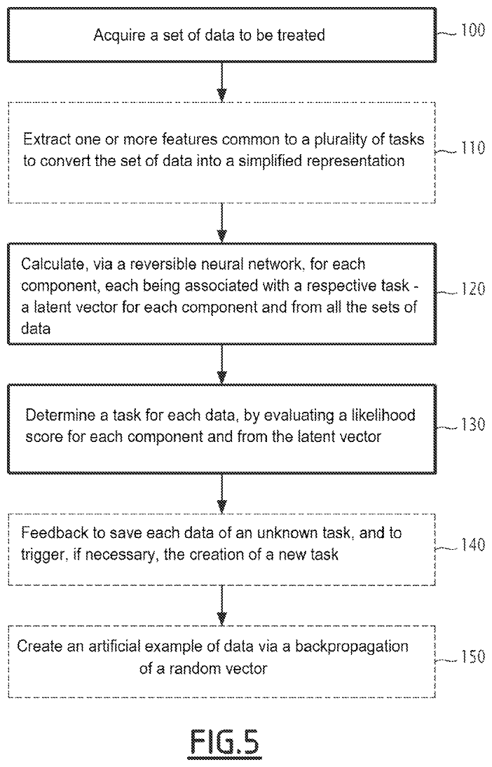

FIG. 5 is a flowchart of a data processing method according to the invention, the method being implemented by the electronic processing device of FIG. 1.

In the present description, unless otherwise specified, when reference is made to two elements being connected to each other, it means that they are connected directly to each other, with no intermediate element between them other than connecting conductors; and when reference is made to two elements being coupled or connected to each other, it means that these two elements are either connected to each other, or coupled or connected to each other through one or more other elements.

In this description, unless otherwise specified, the terms “substantially”, “about”, “approximately” and “of the order of” define a relationship of equality to within plus or minus 10%, preferably plus or minus 5%.

A task, or even class, is a grouping of similar data, or of the same type, and each task has an associated task label. The terms “task” and “class” are considered synonymous for the purposes of the present invention.

By object is meant a concrete realization of a class or task, for example a physical object, a person, and more generally an element present in a scene captured by a sensor, in particular of the type described below. The scene is then typically represented in the form of images or videos in the case of an image sensor or an infrared sensor, in the form of sound in the case of a sound sensor, or in the form of point clouds in the case of a lidar or radar sensor.

In FIG. 1, an electronic detection system 10 is configured to detect one or more objects, not shown, and comprises a sensor 12 and an electronic processing device 14, connected to the sensor 12.

The electronic detection system 10 forms, for example, a face detector capable of recognizing the faces of previously identified persons and/or detecting the faces of unknown persons, namely, the faces of persons who have not been previously identified. The electronic processing device 14 can then learn the identities of detected persons, and also identify unknown persons.

The sensor 12 is known per se and is for example an image sensor configured to take one or more images of a scene and transmit them to the electronic processing device 14.

Alternatively, the sensor 12 is a sound sensor, an object detection sensor, such as a lidar sensor, a radar sensor, an infrared sensor, a capacitive proximity sensor, an inductive proximity sensor, a Hall effect proximity sensor, or a presence sensor, configured to acquire a characteristic signal as a function of the presence or absence of object(s), and then to transmit it to the electronic processing device 14.

The electronic processing device 14 is configured to process a set of data, the set of data typically corresponding to one or more signals captured by the sensor 12. The electronic processing device 14 is then typically configured to interpret a scene captured by the sensor 12, in other words, to identify and/or to recognize a type of one or more elements—such as people or physical objects—present in the captured scene and corresponding to the signal or signals captured by the sensor 12.

The electronic processing device 14 comprises an acquisition module 16 for acquiring the set of data to be processed; a calculation module 18 including a plurality of components 20, visible in FIGS. 2 to 4, each associated with a respective task, each component 20 being capable of calculating a vector in a latent space H, called latent vector h^{k}, from the set of data; and a module 22 for determining a task for each data, from the calculated latent vector h^{k}.

As an optional addition, the electronic processing device 14 further comprises a feedback module 24 configured to store in a buffer memory 26, visible in FIG. 2, each unknown task data and to trigger the creation of a new task if necessary.

As a further optional addition, the electronic processing device 14 further comprises a features extractor module 28, connected between the acquisition module 16 and the calculation module 18, the features extractor module 28 being capable of extracting one or more features common to several tasks in order to transform the set(s) of data into a simplified representation.

As a further optional addition, and as will be described in more detail later with respect to the embodiment of FIG. 4, the electronic processing device 14 further comprises a retraining module 30 configured to generate, from a vector of random or pseudo-random numbers corresponding to the distribution in latent space of one of the components, at least one artificial example of data and its identifier, and then provide them to the component(s) 20 associated with the same identifier, said component(s) 20 being able to retrain, the retraining module 30 including a copy of each component 20 to be retrained.

In the example of FIG. 1, the electronic processing device 14 comprises an information processing unit 40 formed by, for example, a memory 42 and a processor 44 associated with the memory 42.

In the example of FIG. 1, the acquisition module 16, the calculation module 18 and the determination module 22, as well as an optional addition, the feedback module 24, the extraction module 28 and/or the retraining module 30, are each implemented as software, or a software brick, executable by the processor 44. The memory 42 of the electronic processing device 14 is then able to store software for acquiring the set of data to be processed, software for calculating the latent vector for each component from the set of data, and software for determining a task for each data from the calculated latent vectors. As an optional addition, the memory 42 of the electronic processing device 14 is able to store a feedback software capable of storing in the buffer memory 26 each unknown task data and, if necessary, to trigger the creation of a new task, a software for extracting features common to several tasks in order to convert the set(s) of data into a simplified representation and a retraining software able to provide, from a random or pseudo-random vector corresponding to the distribution of the latent space of one of the components, at least one artificial example of data and its identifier, this, to the component(s) with the same identifier as that of the generated artificial example. The processor 44 is then able to execute each of the acquisition software, the calculation software and the determination software, as well as optionally the feedback software, the extraction software and/or the retraining software.

Alternatively, not shown, the acquisition module 16, the calculation module 18 and the determination module 22, as well as an optional addition the feedback module 24, the extraction module 28 and/or the retraining module 30, are each implemented as a programmable logic component, such as an FPGA (Field Programmable Gate Array), or even as a dedicated integrated circuit, such as an ASIC (Application Specific Integrated Circuit).

When the electronic processing device 14 is implemented as one or more software programs, in other words, as a computer program, it is further able to be stored on a computer-readable medium, not shown. The computer-readable medium is, for example, a medium capable of storing electronic instructions and of being coupled to a bus of a computer system. As an example, the readable medium is an optical disk, a magneto-optical disk, a ROM memory, a RAM memory, any type of non-volatile memory (for example, EPROM, EEPROM, FLASH, NVRAM), a magnetic card or an optical card. A computer program comprising software instructions is then stored on the readable medium.

The acquisition module 16 is configured to acquire the set of data to be processed. In the following description, the data space to which this set of data belongs is denoted X, and each acquired set of data is denoted x, and is for example in the form of a vector including the input data(s), also called input vector x.

Additionally, the acquisition module 16 is also configured to perform preprocessing of the acquired data, such as normalizing the acquired data. Alternatively, or even additionally, the acquisition module 16 is further configured to perform an enrichment of the acquired data, such as applying one or more random angle rotations to the acquired data to generate additional data.

The calculation module 18 includes the plurality of components 20, each of which is associated with a single respective task. According to the invention, each component 20 is configured to implement a reversible neural network to calculate from the set(s) of data, such as from the input vector x, a vector in latent space H, also referred to as latent vector h^{k}.

In the example of FIG. 2, the number of components 20 is equal to P, and each component 20 is also then denoted Ck, where k is an integer index with a value between 1 and P. Each component Ck is then configured to calculate the latent vector hk exponent k, as represented in FIG. 2 where the latent vectors h¹, h², . . . h^{P} are then calculated by the calculation module 18 for each input vector x, and more specifically by the respective components C₁, C₂, . . . , C_{P}.

Each reversible neural network is configured to learn a bijective function between the input data space X and the latent space H, and the latent space H is then constrained to be distributed according to a probabilistic distribution function of dimension equal to that of the input space X. The probabilistic distribution function according to which the latent space H is distributed is for example a multidimensional Gaussian, as well as the one according to which the input space X is distributed.

Each reversible neural network includes one or more coupling layers 32, where each coupling layer 32 represents a bijective, transformed between its input and output. In the example of FIG. 3, each component 20 of the calculation module 18 includes a coupling layer with four input/output dimensions, and the transformed bijective associated with the coupling layer 32 of component C₁ is, for example, the function g, and the following equations are, for example, satisfied in the example of that coupling layer of component C₁:

y=g(x) (1)

y₁=g₁(x₂)+x₁ (2)

y₂=g₂(y₁)+x₂ (3)

x=g⁻¹(y) (4)

x₂=y₂−g₂(y₁) (5)

x₁=y₁−g₁(x₂) (6)

In the example shown in FIG. 3, each reversible neural network in a component 20 further includes a scaling adaptation layer 34, and the parameters of this adaptation layer 34 are also trainable.

The skilled person will of course note that the reversible neural network of a component 20 is likely to include a plurality of coupling layers 32, where the coupling layers 32 are then connected in sequence, so as to always preserve the same size of space between the input and the output, as illustrated in FIG. 3 for the coupling layers 32 of the reversible neural network included in the extraction module 28.

FIG. 3 also illustrates the connection of several reversible neural networks to a common reversible neural network, when the extraction module 28 includes one or more reversible neural networks connected one after the other, with the last reversible network in that sequence being connected to each of the reversible neural networks associated with the components 20 arranged in parallel. In particular, for each dimension, the output node of the last common reversible network is connected to the input node of the same dimension of each of the input reversible neural networks of the components 20, as shown in FIG. 3.

In FIG. 3, the common reversible neural network(s) (represented on the left side of the figure) then act as a common feature extractor for the plurality of tasks for all of the reversible neural networks of the components 20 (represented on the right side of the figure), which are arranged in parallel with each other and specific to each task.

The determination module 22 is configured to determine a task for each data by evaluating, for each component 20, denoted Cₖ, a likelihood score from the corresponding latent vector h^{k}; and assigning, to said data, the task of the identifier k associated with the component 20 with the highest likelihood score among the plurality of evaluated likelihood scores; and if the evaluated likelihood score is inconsistent for the component 20 associated with the assigned task, by modifying the assigned task to an unknown task.

Each likelihood score evaluated by the determination module 22 is, for example, a logarithmic score, and each likelihood score then preferably includes the following logarithmic term

log[p_{H}^{k}(F^{k}(x))] (7)

where p_{H} represents a probabilistic distribution function of the latent space H,

k is an integer index representing each component, k typically being between 1 and P, with P representing the number of components, P≥2,

F^{k} is an invertible, or bijective, function relating a latent vector h^{k} to the given vector x: h^{k}=F^{k}(x);

Every probabilistic distribution function in the latent space H satisfies, for example, the following equation:

p_{H}(h)=Π_{d}p_{H}_{_{d}}(h_{d}) (8)

where d represents the number of dimensions of the input space X and the latent space H, which is identical for both spaces, due to the use of reversible neural networks.

The skilled person will then observe that in equation (8) the components h_{d} are independent of each other, so that the latent space H factorizes.

Furthermore, since the function F is invertible, the probabilistic distribution function of the input space X satisfies the following equation:

$${p}_{X}^{k} ( x ) = {p}_{H}^{k} ( {F}^{k} ( x ) ) \vert det \frac{\partial {F}^{k} ( x )}{\partial x} \vert \qquad ( 9 )$$

where the term

$$\vert det \frac{\partial {F}^{k} ( x )}{\partial x} \vert$$

represents the Jacobian determinant of the transformation function F^{k}(x)

When the probabilistic distribution function of the input space X satisfies the previous equation (9), the log likelihood score is typically written in the following form:

$$log {p}_{X}^{k} ( x ) = log {p}_{H}^{k} ( {F}^{k} ( x ) ) + log \vert det \frac{\partial {F}^{k} ( x )}{\partial x} \vert \qquad ( 10 )$$

The log likelihood score according to equation (10) then includes the log term from the previous equation (7).

The reversible neural network of each component 20 includes parameters θ, with the parameters of each component Cₖ then noted as θ^{k}, and said parameters are preferably optimized via a maximum likelihood method.

The training of the reversible neural network(s) of each component is then preferably performed via a backpropagation algorithm for calculating the gradient of each parameter θ.

The learning of each network is preferably still continuous, and in particular performed after each data processing.

The optimized parameters θ^{k}* of the reversible neural network(s) of each component Cₖ then satisfy, for example, the following equation:

θ^{k}*=argmax_{θk} log p_{X}^{k}(x) (11)

The skilled person will then observe that the maximum likelihood estimation is performed independently, in other words, separately, for each component Cₖ, namely, independently for each value of the index k.

The determination module 22 is then configured to determine the task for each data, by assigning to said data the task of index k that is associated with the component with the highest likelihood score among the plurality of evaluated scores, and the identifier, or label, of said task then typically satisfies the following equation:

t*=t(argmaxₖ log p_{X}^{k}(x)) (12)

Alternatively, the identifier of said task is determined according to the following equation:

t*=t(argmaxₖ log p_{H}^{k}(F^{k}(x))) (13)

The skilled person will then notice that the determination of said identifier according to the previous equation (13) uses a simplified log likelihood score based only on the latent term of the likelihood score, in other words on the term log p_{H}^{k}(F^{k}(x)), and not taking into account the term corresponding to the logarithm of the Jacobian determinant of the transformation function, namely, the term

$$log \vert det \frac{\partial {F}^{k} ( x )}{\partial x} \vert .$$

The inventors have indeed observed that the use of only the latent term log p_{H}^{k}(F^{k}(x)) yields better results when task determination is used for data classification and/or class boundary detection, whereas the use of the full log likelihood score according to the previous equation (12) is preferable for the optimization of each reversible neural network. It is believed that this is probably due to the fact that the log likelihood score term corresponding to the logarithm of the Jacobian determinant, namely, the

$$log \vert det \frac{\partial {F}^{k} ( x )}{\partial x} \vert$$

term, is likely to contract, or on the contrary relax, the volume of the latent space, which is then likely to lead to quite noticeable differences in the likelihood scores from one task to another. If this

$$log \vert det \frac{\partial {F}^{k} ( x )}{\partial x} \vert$$

term is ignored, then the volume of the latent space H of each component Cₖ is then equivalent to that of the input space X, which allows for a better connection between the different components Cₖ. However, the quality of artificial example(s) generated using inverse propagation of random or pseudo-random vector(s), as well as those that will be described in more detail later, is much better, especially less noisy, when the inverse propagation is performed from the latent space H toward the input space X through layers of inverse neural networks that have been trained and optimized using the full likelihood score according to the equation (10), namely by determining the identifier of each task according to the equation (12) during this optimization phase.

The probabilistic distribution function p_{H} of the latent space H is usually a factorized standard normal distribution function, such as the distribution function satisfying for example the following equation:

$${p}_{H}^{k} ( {F}^{k} ( x ) ) = {\prod }_{d} {p}_{{H}_{d}}^{k} ( {F}^{k} ( x ) ) = {\prod }_{d} \frac{1}{\sqrt{2 π} {σ}_{d}^{k}} {e}^{- \frac{1}{2} {( \frac{{F}_{d}^{k} ( x ) - {μ}_{d}^{k}}{{σ}_{d}^{k}} )}^{2}} \qquad ( 14 )$$

where μ_{d}^{k}, and respectively σ_{d}^{k}, represent the mean, and respectively the standard deviation, of the d-dimensional probabilistic distribution function, such as the multidimensional Gaussian.

The determination module 22 is configured to determine that the evaluated likelihood score is inconsistent for the component 20 associated with the assigned task if the deviation between the evaluated likelihood score and an average likelihood score for said component 20 is greater than a threshold. This threshold is, for example, a predefined value for each component 20, or even a percentage of an observed average value for each component 20.

Alternatively, the determination module 22 is configured to detect that the evaluated likelihood score is inconsistent, and that the assigned task should then be modified to an unknown task by applying a method known as out-of-distribution detection, also noted as OOD, to the evaluated likelihood score.

As an optional addition, the determination module 22 is further configured to transmit the calculated latent vectors hk to another electronic data processing device, such as a k-NN (K-Nearest Neighbor) classifier, in other words, a classifier implementing the k-nearest neighbor algorithm, or another machine learning algorithm, such as artificial neural network(s).

In addition, the determination module 22 is further configured to generate a vector of random or pseudo-random number(s) corresponding to the distribution of the latent space H of one of the components 20, and then to propagate said random or pseudo-random vector in an inverse manner via the corresponding reversible neural network, in other words, via the network of reversible neurons of the component corresponding to the distribution of the latent space taken into account, in order to create an artificial example 52 of data, a task identifier associated with this artificial example 52 being then the identifier of said component via which the inverse propagation was performed.

In the example of FIG. 2, the creation of the artificial example 52 is illustrated for component C₅, and the inverse propagation of the random or pseudo-random vector is represented by the random vector hₛ⁵ generated by the determination module 22 toward the component C₅, then propagated in an inverse manner toward the input space X, as represented by the arrows G1, G2 and G3.

According to this addition, the random or pseudo-random vector, namely, the vector hₛ⁵ in the example of FIG. 2, or the vector hₛ² in the example of FIG. 4, is propagated in an inverse manner toward the calculation module 18 as in the example of FIG. 2, or to the retraining module 30 distinct from the calculation module 20 as in the example of FIG. 4.

The random vector hₛ^{k} then satisfies the following equation:

hₛ^{k}˜p_{H}^{k} (15)

and the artificial example 52 thus created via this inverse propagation, also noted xₛ(k) then satisfies the following equation:

xₛ(k)=F^{-1,k}(hₛ^{k},θ^{k}*) (16)

According to this addition, the electronic processing device 14 then allows, in other words, generates samples xₛ of the learned distribution pₓ(x,θ*) by drawing a random sample from the latent space distribution function, and transferring this random sample to the input space by inverse propagation, namely by applying the inverse function F⁻¹, to the random sample of the latent space distribution function H. The preceding equations (15) and (16) correspond to the case where the latent space distribution function is a standard factorized equation. The skilled person will further observe that the complexity of the calculations associated with the generation of such a sample is then equivalent to that implemented to optimize the parameters of the neural networks of the components 20 of the calculation module 18 via the maximum likelihood method, in the direction of inference, namely, from the input space X to the latent space H.

The feedback module 24 is configured to store in the buffer memory 26 each unknown task data, that is, each task data the evaluated likelihood score of which is inconsistent, and to trigger the creation of a new task if necessary.

For example, the feedback module 24 is configured to trigger the creation of a new task if the number of data stored in the buffer memory 26 is greater than a predefined number. The calculation module 18 is then configured to include a new component 20 associated with the new task created by the feedback module 24, as represented by the arrow R1 in the examples of FIGS. 2 and 4 and learning of the new component 20 is then performed from said data stored in the buffer memory 26.

As an optional addition, the extraction module 28, connected between the acquisition module 16 and the calculation module 18, is configured to implement at least one neural network to convert the sets of data, such as the acquired data vector X, into a simplified representation, by then extracting one or more features common to the plurality of tasks. Each neural network in the extraction module 28 is preferably a reversible neural network.

In the example of FIGS. 2 and 4, the extraction module 28 advantageously consists of a first extractor 60 configured to implement a neural network with frozen weights following the training of said network and of a second extractor 62 configured to implement a neural network with trainable weights via continuous training, such as a training performed after each data processing, in particular via an inverse propagation algorithm when the first and second extractors 60, 62 each comprise reversible neural networks.

The person skilled in the art will then understand that the architecture of the electronic processing device 14 according to this optional addition is specific in that it comprises two parts, namely a task agnostic part corresponding to the extraction module 28, and in particular to the first feature extractor 60 and the second feature extractor 62, and a task specific part comprising several independent coupling layers, namely the components 20, which are all connected in parallel to the agnostic part of the tasks. This two part architecture with a task agnostic part and a task specific part then allows for better continuous learning.

In particular, the task-specific part, namely, the calculation module 18 including the mutually independent components 20, corresponds to high-level components of the distribution to be modeled, and given that their weights are independent, they are not subject to the catastrophic forgetting phenomenon. The task agnostic part is allowed to play the role of extractor of features common to all the components 20 but is however subject to the catastrophic forgetting phenomenon if the tasks are learned in a sequential way. The task agnostic portion, however, allows for far fewer parameters to be used, given that the task agnostic features are usable simultaneously by all components 20 that are task specific. Furthermore, if the low-level features of all the tasks are similar, which is typically the case if learning is performed on a specific set of data, then each additional task is learned more quickly and with fewer examples, by being based on the already existing task agnostic features.

In the example of FIGS. 2 and 4, the features common to the plurality of tasks are symbolized by the functions f₀ to f_{N-1} for the first extractor 60, and then by the functions f_{N} to f_{M-1} for the second extractor 62, and the features specific to each task are then symbolized by the functions f_{M}^{k}, f_{M+1}^{k}, to f_{L}^{k} where k represents the identifier of the task.

The skilled person will then understand that the first extractor 60 is configured to implement a compound of the functions f₀ to f_{N-1} in the direction of inference or learning, namely, from the data space X to the latent space H, as represented by the arrows IL1, IL2 and IL3, and inversely to implement the function compound f₀⁻¹ to f_{N-1}⁻¹ in the reverse direction, for example, for generating artificial examples 52 from the latent space H to data space X, as represented by arrows G1 to G3.

In a similar manner, the second extractor 62 is configured to implement a composite of the functions f_{N} to f_{M-1} in the direction of inference or learning from the data space X to the latent space H, and inversely implement a composite of the inverse functions f_{N-1} to f_{M-1}⁻¹ in the direction of generating artificial examples from the latent space H to the data space X.

In a still similar way, each component Cₖ is configured to implement a composite of the specific functions f_{M}^{k} to f_{L}^{k} in the direction of inference and learning from the data space X to the latent space H, and inversely only the component associated with the generated random vector, such as component C₅ in the example of FIG. 2 or component C₂ in the example of FIG. 4, is configured to implement in the reverse direction a composite inverse function, such as the composite of the inverse functions (f_{M}⁵)⁻¹ to (f_{L}⁵)⁻¹ in the example of FIG. 2, or such as the composite of the inverse functions (f_{M}²)⁻¹ to (f_{L}²)⁻¹ in the example of FIG. 4

The person skilled in the art will then understand that each latent vector hₖ satisfies the following equation in these examples in FIGS. 2 and 4:

hₖ=Fₖ(x)=f_{L}^{k}∘ . . . ∘f_{M+1}^{k}∘f_{M}^{k}∘f_{M-1}∘ . . . ∘f₀(x) (17)

Similarly, every artificial example x generated using the component Cₖ in reverse satisfies the following equation:

x(k)=F^{-1,k}(h^{k})=f₀⁻¹∘ . . . ∘f_{M-1}⁻¹∘f_{M}^{-1,k}∘f_{M+1}^{-1,k}∘ . . . ∘f_{L}^{-1,k}(h^{k}) (18)

with the following notation convention: (f_{M}^{k})⁻¹=f_{M}^{-1,k}

The skilled person will further understand that, in equation (17), the composite of the functions f₀ to f_{M-1} corresponds to the task agnostic part, namely the optional extraction module 28, and the composite of the functions f_{M}^{k} to f_{L}^{k} corresponds to the task specific part, in this case the task specific part of identifier k, namely, the component Cₖ.

Similarly, in equation (18), the composite of the inverse functions f₀⁻¹ to f_{M-1}⁻¹ corresponds to the task agnostic part, namely, the optional extraction module 28, and the composite of the inverse functions (f_{M}^{k})⁻¹ to (f_{L}^{k})⁻¹ corresponds to the task specific part, in particular, the reverse implementation of the component Cₖ.

When, as an optional addition, the electronic processing device 14 further comprises the extraction module 28 connected between the acquisition module 16 and the calculation module 18, in particular further includes the second extractor 62, the feedback module 24 is configured to transmit the new data stored in the buffer memory 26 to both the calculation module 18 for inclusion of a new component 20 associated with the new task according to the arrow R1; and also to the extraction module 28, in particular to the second extractor 62 the neural network(s) of which include trainable weights, the second extractor 62 then also being trained with such data from the feedback module 24, as represented by the arrow R2.

The electronic processing device 14 according to the invention then offers various applications. A first application is data classification, and the task or class, predicted for each data to be processed is then determined by searching for the component 20 presenting the highest likelihood score among the plurality of scores evaluated for the different components 20, the determined task then being the one associated with the component having the highest likelihood score. The label t of the determined task then satisfies for example equation (12), or preferably even equation (13) which does not take into account the volume term, namely, which does not take into account the logarithm of the Jacobian determinant, and therefore provides better results.

The skilled person will observe that several component identifiers k can be assigned to the same label, or identifier, of task t.

A second application of the electronic processing device 14 according to the invention is component labeling, or even component identification, such labeling being obtained for example via supervised learning, which then means that the task label t is provided with the data x, and the calculation module 18 then includes a single component 20 for each task.

Alternatively, this component labeling is performed in an unsupervised manner, and the processing device 14 is then configured to perform unsupervised task learning, each component 20 of the calculation module 18 then being configured to calculate a vector in the latent space H for each new data item, the latent space H then including latent vectors h^{k} for this new data item, and an identifier of the component 20 being furthermore associated with each latent vector h^{k} calculated.

For this unsupervised learning, according to a first alternative, the determination module 22 is for example further configured to modify the component 20 identifiers from a batch of identified examples, a respective identifier being associated with each example; this by assigning for each example its identifier to the component 20 presenting the highest likelihood score, the component(s) having no identifier assigned after taking into account all the examples of the batch being then ignored. According to this variant, in unsupervised learning, several components 20 of the calculation module 18 are likely to represent the same task.

For this unsupervised learning, according to a second alternative corresponding to an autonomous labeling, the task labels are already assigned during learning using a continuous labeling process. According to this second alternative, each time the processing device 14 detects a new task, the current task label is then incremented, and all subsequent examples are treated as corresponding to this label until a new task is detected by the processing device 14, in particular by the determination module 22. When a new component is added to the calculation module 18, as a result of the detection of a new task, that component is then assigned with the label of the new task. The skilled person will observe that the labeling according to this second unsupervised learning alternative is then based on the interpretation of the processing device 14, and in particular of its neural networks, and the tasks thus identified do not then necessarily correspond to real tasks in the environment.

A third application of the electronic processing device 14 is the detection of off-distribution data for classification and/or for task boundary detection. This third application preferably corresponds to unsupervised learning without a previously assigned task label. However, the skilled person will note that the detection of unknown task(s) or class(es) also allows, when the processing device 14, and in particular its neural networks, are in pure inference mode, and no new component is added, to calculate an estimate of a response certainty of the neural network(s). The detection of unknown task(s) according to this third application is then performed, as previously described, by detecting that a likelihood score evaluated by the determination module 22 is inconsistent for the component 20 associated with the assigned task, such inconsistency typically corresponding to a deviation between the evaluated likelihood score and the average likelihood score for said component, greater than a threshold. The skilled person will then understand that this application of unknown task(s) detection is likely to be implemented only after the implementation of a start-up phase during which a certain number of iterations is performed for each component 20, this until it converges toward the distribution of a respective task, and during this start-up phase no unknown task(s) is likely to be detected.

The threshold used to detect new tasks, via an inconsistency of the evaluated likelihood score, is for example a predefined value for each component or even a percentage of an observed average value for each component. In the latter case, the evaluated likelihood score is then considered as inconsistent from the moment it deviates from the said percentage relative to the average likelihood score observed for the said component.

According to this third application, the samples that are considered unknown are then added to the buffer memory 36, and when the number of unknown samples is greater than the aforementioned predefined number, the determination module 22 considers that the task has changed, i.e. was modified, and a learning is then performed for the new task, as represented by the arrows R1, R2 and described previously.

In addition, the feedback module 24 is configured to regularly clear the buffer memory 26, for example, if after a small number of unknown samples, a large number of known examples, in other words, associated with already known tasks, is encountered again. Such regular clearing of the buffer memory 26 by the feedback module 24 then prevents the addition of a new task that would be based on disparate unknown examples obtained over time until the number of unknown data exceeds the predefined number of triggers for creating a new task.

A fourth application of the electronic processing device 14 according to the invention is the autonomous and dynamic addition of components 20 within the calculation module 18. Indeed, as previously described, when a new task has been detected, a new component 20 is initialized within the calculation module 18, this for example with random weights, or even with the weights of the component 20 (among those already existing) having the highest likelihood score for the data stored in the buffer memory 26.

This new component 20, and if applicable the second extractor 62, is then trained for the number of iterations corresponding to the start-up phase, described above, for example, via a gradient-based optimization from the data stored in the buffer memory 26, which then allows the new component 20 to converge toward the distribution of the new task. Alternatively, instead of using a defined number of iterations in this startup phase, the startup phase for training the new component 20 is performed until a convergence criterion is satisfied.

The new component 20 thus added to the calculation module 18 then represents the distribution of the new task, and the buffer memory 26 is then cleared. Learning is then continued with the newly acquired data, which is then assigned to the new component, until a next new task is detected.

According to an additional aspect corresponding to the second embodiment of FIG. 4, the electronic processing device 14 according to the invention further comprises the retraining module 30, the latter being distinct from the calculation module 18, and if applicable from the extraction module 28.

According to this additional aspect, the retraining module 30 is configured to receive the random or pseudo-random vector hₛ^{k} (such as the vector hₛ² in the example of FIG. 4), generated by the determination module 22 for the component of index k that is to be retrained, and the retraining module 30 is then configured to provide at least one artificial example 52 of data(s) and its identifier, this to the component 20 of the calculation module 18 that is associated with the same identifier k, such as the value identifier 2 in the example of FIG. 4.

According to this additional aspect, the retraining module 30 then includes a copy of each component 20 that is to be retrained.

When the electronic processing device 14 comprises, as an optional addition, the extraction module 28 including in particular the second extractor 62, the retraining module 30 further includes a copy of the second extractor 62, and the retraining module 30 is then further configured to provide each artificial example 52 of data to the extraction module 28, and in particular to its second extractor 62, for retraining thereof, as represented by arrow G′4.

The skilled person will further understand that—in a similar manner to what has been explained for the generation of artificial examples 52 according to the first embodiment in view of FIG. 2—the retraining module 30 is configured to create each artificial example 52 of data by performing, in a reverse manner, a propagation of the random or pseudo-random vector through the considered component 20 which is a copy of the component 20 of the calculation module 18 that is to be retrained, as illustrated by the arrow G′1 in FIG. 4; and if necessary through the second extractor 62 the neural network(s) of which are then reversible, as illustrated by the arrow G′2 in FIG. 4, the second extractor 62 contained in the retraining module 30 being a copy of the second extractor 62 of the extraction module 28.

The copy is made each time before a new component 20 is added. In the case of unsupervised learning with automatic task detection via the buffer memory 26, the copy is made before the component 20, and if applicable the second extractor 62, are trained with data from the buffer memory 26.

The operation of the electronic processing device 14 according to the invention will now be described with reference to FIG. 5 showing a flow chart of the processing method according to the invention, the latter being implemented by the processing device 14.

In a first step 100, the processing device 14 acquires, via its acquisition module 16, the set of data to be processed, the latter typically being in the form of a data vector x.

During this acquisition step 100, the acquisition module 16, as an optional addition, performs a normalization of the set(s) of data and/or an enrichment of the set(s) of data, for example, via one or more random angle rotations.

When, as an optional addition, the processing device 14 includes the extraction module 28, it extracts, during a following optional step 110 and via its extraction module 28, one or more features common to several tasks in order to convert the acquired set of data into a simplified representation, which then allows the specific part of each task to be implemented more quickly, via the calculation module 18. Indeed, this optional step 110 corresponds to a task agnostic step, which is implemented by the extraction module 28 and which corresponds to the part of the architecture of the processing device 14 that is task agnostic, as explained above.

At the end of the acquisition step 100, or if necessary at the end of the optional extraction step 110, the processing device 14 calculates, during the following step 120 and via its calculation module 18, a latent vector hₖ for each component 20 included in the calculation module 18 and from the set(s) of data, in other words, either from the data vector x acquired during the acquisition step 100 or from the simplified representation obtained at the end of the optional extraction step 110.

According to the invention, each component 20 associated with a respective task and calculating the latent vector hₖ is configured to implement a reversible neural network, and this possibility of inverting the neural network of each component 20 then makes it possible to express the likelihood function of the input data easily as a function of the values of the latent space H, in other words, easily as a function of the latent vector hₖ, in the subsequent step 130.

At the end of the step 120 of calculating each latent vector hₖ, the processing device 14 in fact determines, during the step 130 and via its determination module 22, a task for each data by evaluating the likelihood score for each component, this from the latent vector hₖ computed for each component 20. In this determination step 130, the determined task is then the one associated with the component 20 presenting the highest likelihood score, and the label t of the determined task satisfies for example the equation (12) or the equation (13).

When, as an optional addition, the processing device 14 further comprises the feedback module 24, the processing device 14 then performs in the next step 140 and via said feedback module 24, a storage in the buffer memory 26 of each unknown task data, namely, of each data for which the evaluated likelihood score is inconsistent for the component associated with the assigned task, which is then considered as unknown.

During this optional feedback step 140, the feedback module 24 further triggers the creation of a new task, if necessary, for example if the number of data stored in the buffer memory 26 is greater than the predefined number. If appropriate, the calculation module 18 is preferably configured to then include a new component 20 associated with the new task and learning of the new component 20 is performed from the data stored in the buffer memory 26, as described above.

Finally; the processing device 14 optionally performs, in the next step 150, and via its back propagation calculation module 18 according to the first embodiment of FIG. 2, or via its retraining module 30 according to the second embodiment of FIG. 4, the creation of at least one artificial example 52 of data from the random or pseudo-random vector hₛ^{k} generated by the determination module 22. Specifically, the random or pseudo-random vector hₛ^{k} is generated by the determination module 22 to correspond to the latent space distribution of the component Cₖ that is to be retrained, and this vector hₛ^{k} is then back propagated from the latent space H to the input space X via the reversible neural network of the component Cₖ to be retrained in the example of FIG. 2, or via the reversible neural network of the copy of the component Cₖ to be retrained that is included in the retraining module 30 in the example of FIG. 4. The artificial example, along with its identifier, thus created is then provided to the component Cₖ of the calculation module 18 which is associated with the same identifier k.

When, as an optional addition, the processing device 14 also includes the extraction module 28, the latter then being composed of reversible neural networks, the random or pseudo-random vector hₛ^{k} is also propagated through said extraction module 28 in a reverse manner, as represented in FIG. 2 by the arrows G1 and G2. In the example of FIG. 4 corresponding to the second embodiment, when as an optional addition the retraining module 30 also includes a copy of said second extractor 62, the random or pseudo-random vector hₛ^{k} is then propagated in a reverse manner through the copy of said second extractor 62, then the artificial example 52 thus created by the retraining module 30 is then also provided to the second extractor 62 of the extraction module 28. In this case, if the second extractor 62 is trainable, it is, like the component Cₖ, retrained on the artificial example, by gradient backpropagation of the component Cₖ. The processing device 14 according to the invention then makes it possible to carry out continuous learning based on generative neural networks, these neural networks being moreover invertible, which then makes it possible to express the likelihood function of the data of the input space X more easily, as a function of the values of the vectors of the latent space H.

The person skilled in the art will observe that the processing device 14 according to the invention allows for both unsupervised and supervised learning to be performed, as previously explained through the first, second, third and fourth applications described.

The reversible networks also allow an exact calculation of the likelihood score of the data of the input space X according to the probabilistic distribution function of this input space, and then to determine if the likelihood score of a sample is inconsistent for the component associated with the assigned task, which then allows the detection of an unknown task in unsupervised learning.

Furthermore, according to the first embodiment of FIG. 2, the use of reversible neural networks for each component 20 of the calculation module 18 allows for the use of a unique neural network for both encoding from input space X to latent space H and for decoding from said latent space H to said input space X, this decoding then allows for the creation of artificial examples 52 for subsequent retraining of the neural networks of the components 20.

The additional aspect corresponding to the second embodiment in FIG. 4 where the processing device 14 further includes the retraining module 30 distinct from the calculation module 18 then allows for the generation of artificial examples 52 by the retraining module 30 at the same time as the calculation module 18 continues to perform task learning, thereby more easily and regularly creating artificial examples 52 for the subsequent retraining of the corresponding neural networks of component 20.

Furthermore, in any embodiment, the reversible neural networks of the components 20 of the calculation module 18 and, if applicable, the reversible neural network of the second extractor 62, allow the gradient backpropagation algorithm to be implemented with a smaller amount of memory resources as the activations of each neuron can be reconstructed from the output of the corresponding network. This then allows the activations to be recalculated in parallel during the gradient backpropagation, without having to save the activations of each neuron during an inference phase, and this lesser use of memory resources is then particularly suitable when the processing device 14 according to the invention is implemented in an embedded system.

It is thus conceived that the electronic processing device 14, and the associated processing method, according to the invention provide a better solution to the phenomenon of catastrophic forgetting by better representing tasks and then by learning features that are more discriminating.

1. An electronic data processing device configured to process a set of data, the set of data corresponding to one or more signals captured by a sensor, the device comprising:
an acquisition module configured to acquire the set(s) of data to be processed;
a calculation module including a plurality of components, each associated with a respective task, each component being configured to implement a reversible neural network to calculate a vector in a latent space, called latent vector, from the set of data; and
a determination module configured to determine a task for each data, by:
evaluating, for each component, a likelihood score from the corresponding latent vector; and
assigning, to said data, the task associated with the component with the highest likelihood score among the plurality of evaluated scores; and
if the evaluated likelihood score is inconsistent for the component associated with the assigned task, modifying the assigned task to an unknown task.

2. The device according to claim 1, wherein the device further comprises a feedback module configured to store each unknown task data in a buffer memory, and to trigger the creation of a new task if the number of data stored in the buffer memory is greater than a predefined number;
the calculation module then being configured to include a new component associated with the new task; the learning of the new component being performed from said data stored in the buffer memory.

3. The device according to claim 1, wherein the reversible neural network of each component includes parameters, such as weights; said parameters being optimized via a maximum likelihood method.

4. The device according to claim 1, wherein the device further comprises a feature extraction module connected between the acquisition module and the calculation module, the extraction module being configured to implement at least one neural network to convert the set(s) of data into a simplified representation, by extracting one or more features common to the plurality of tasks.

5. The device according to claim 1, wherein the determination module is further configured to generate a vector of random or pseudo-random numbers corresponding to the distribution of the latent space of one of the components, and then to propagate said vector in an inverse manner via the corresponding reversible neural network, in order to create an artificial example of data, a task identifier associated with this artificial example being an identifier of said component.

6. The device according to claim 5, wherein the device further comprises a retraining module configured to receive the vector generated by the determination module and to provide at least one artificial example of data and its identifier to the component(s) of the calculation module associated with the same identifier, said component(s) to be re-trained, the re-training module including a copy of each component to be re-trained.

7. The device according to claim 6, wherein the device further comprises a feature extraction module connected between the acquisition module and the calculation module, the extraction module being configured to implement at least one neural network to convert the set(s) of data into a simplified representation, by extracting one or more features common to the plurality of tasks; and
wherein when the extraction module includes the first extractor and the second extractor, the retraining module further includes a copy of the second extractor, the retraining module then being further configured to provide at least one artificial example of data to the second extractor of the extraction module.

8. The device according to claim 1, wherein the device is configured to perform unsupervised task learning, each component of the calculation module being configured to calculate a vector in the latent space for each new datum, the latent space then including latent vectors for that new datum, an identifier of the component further being associated with each calculated latent vector.

9. The device according to claim 8, wherein the determination module is further configured to modify the identifiers of components from a batch of identified examples, a respective identifier being associated with each example, by assigning for each example its identifier to the component presenting the highest likelihood score, the component or components not having an assigned identifier after taking into account all the examples of the batch being ignored.

10. An electronic system for detecting objects, the system comprising a sensor and an electronic processing device for processing data connected to the sensor,
wherein the electronic processing device is according to claim 1, and each data to be processed is an element present in a scene captured by the sensor.

11. A method for processing a set of data, the set of data corresponding to one or more signals captured by a sensor, the method being implemented by an electronic processing device and comprising:
acquiring the set of data to be processed;
calculating, via the implementation of a reversible neural network for each component of a plurality of components, a vector in a latent space, called latent vector, for each component and from the set of data, each component being associated with a respective task; and
determining a task for each data, by:
evaluating, for each component, a likelihood score from the corresponding latent vector; and
assigning, to said data, the task associated with the component with the highest likelihood score among the plurality of evaluated scores; and
if the evaluated likelihood score is inconsistent for the component associated with the assigned task, modifying the assigned task to an unknown task.

12. A non-transitory computer-readable medium including a computer program including software instructions that, when executed by a computer, implement a method according to claim 11.

13. The device according to claim 3, wherein the parameters are weights.

14. The device according to claim 3, wherein the learning of said network is performed via a backpropagation algorithm for the calculation of the gradient of each parameter.

15. The device according to claim 3, wherein the learning of said network is continuous.

16. The device according to claim 15, wherein the learning of said network is carried out after each data processing.

17. The device according to claim 4, wherein each neural network of the extraction module is invertible.

18. The device according to claim 4, wherein the extraction module includes a first extractor configured to implement a neural network with fixed weights following the training of said network and a second extractor configured to implement a neural network with trainable weights via continuous training.

19. The device according to claim 18, wherein the training is carried out after each processing of data.

20. The device according to claim 18, wherein the training is carried out via an inverse propagation algorithm.

21. The device according to claim 5, wherein said vector is back propagated to the calculation module.

22. The device according to claim 5, wherein said vector is back propagated to a retraining module distinct from the calculation module.

23. The system according to claim 10, wherein the sensor is chosen from among the group consisting in: an image sensor, a sound sensor and an object detection sensor.

24. The system according to claim 10, wherein each data to be processed is an object detected in an image.
